(19) United States
(12) Patent Application Publication
(10) Pub. No.: US 2026/0242628 A1
(43) Pub. Date: Aug. 20, 2026

(54) Ink Jet Recording Method

(71) Applicant: SEIKO EPSON CORPORATION, Tokyo (JP)

(72) Inventor: Kenichi SEGUCHI, Okaya (JP)

(21) Appl. No.: 19/541,958

(22) Filed: Feb. 17, 2026

(30) Foreign Application Priority Data
Feb. 18, 2025 (JP) 2025-024552

(51) Int. Cl. C09D 11/38; B41J 2/01; C09D 11/101

(52) U.S. Cl. CPC C09D 11/38; B41J 2/01; C09D 11/101

(57) ABSTRACT

An ink jet recording method includes a first ejection step of ejecting a primer composition from an ink jet head to attach the primer composition to a recording medium so that a duty calculated by the following formula (1) is 5% to 50%; a first irradiation step of curing the primer composition attached to the recording medium by radiation irradiation to form a primer layer; and a second ejection step of ejecting an ink composition to attach the ink composition onto the primer layer.

$$( 1 ) : Duty = ( number of actual printed dots ) / ( vertical resolution \times horizontal resolution ) \times 100$$

The present application is based on, and claims priority from JP Application Serial Number 2025-024552, filed Feb. 18, 2025, the disclosure of which is hereby incorporated by reference herein in its entirety.

### BACKGROUND

### 1. Technical Field

The present disclosure relates to an ink jet recording method.

### 2. Related Art

Ink jet recording methods can record high-definition images using a relatively simple apparatus, and achieve rapid development in various fields. Among these, various studies have been made regarding adhesion and the like. For example, JP-A-2024-044565 discloses a printing apparatus in which an ultraviolet-curable transparent ink is ejected onto a printing medium, the ejected transparent ink is cured by irradiation with ultraviolet rays, and then a color ink is ejected onto the cured transparent ink.

However, although adhesion between a primer composition and an ink composition is improved as disclosed in JP-A-2024-044565, surface roughness of the cured ink composition may be a problem. Such surface roughness causes poor image quality of recorded matter, and thus is required to be improved. That is, there is still a problem in achieving both adhesion and suppression of surface roughness.

### SUMMARY

The ink jet recording method of the present disclosure includes a first ejection step of ejecting a primer composition from an ink jet head to attach the primer composition to a recording medium so that a duty calculated by the following formula (1) is 5% to 50%, a first irradiation step of curing the primer composition attached to the recording medium by radiation irradiation to form a primer layer, and a second ejection step of ejecting an ink composition to attach the ink composition onto the primer layer.

$$( 1 ) : Duty = ( number of actual printed dots ) / ( vertical resolution \times horizontal resolution ) \times 100$$

### BRIEF DESCRIPTION OF THE DRAWINGS

FIG. 1 illustrates an example of a recording apparatus used in an embodiment.

FIG. 2 is a table showing the compositions of Preparation Examples 1 to 4.

FIG. 3 is a table showing the composition of Preparation Example 5.

FIG. 4 is a table showing results of Examples and Comparative Examples.

### DESCRIPTION OF EMBODIMENTS

An embodiment of the present disclosure (hereinafter, referred to as “the present embodiment”) will be described in detail with reference to the drawings as necessary, but the present disclosure is not limited thereto, and various modifications can be made without departing from the gist of the present disclosure. In the drawing, the same elements are denoted by the same reference numerals and the repetitive description will be omitted. In addition, positional relationships such as up, down, left, and right are based on the positional relationships shown in the drawing unless otherwise specified. In addition, the dimensional ratios in the drawing are not limited to ratios shown in the drawing.

In the present specification, “(meth)acryloyl” means at least one of acryloyl and methacryloyl corresponding thereto, “(meth)acrylate” means at least one of acrylate and methacrylate corresponding thereto, and “(meth)acryl” means at least one of acryl and methacryl corresponding thereto.

### 1. Ink Jet Recording Method

The ink jet recording method of the present embodiment includes a first ejection step of ejecting a primer composition from an ink jet head to attach the primer composition to a recording medium so that a duty calculated by the following formula (1) is 5% to 50%, a first irradiation step of curing the primer composition attached to the recording medium by radiation irradiation to form a primer layer, and a second ejection step of ejecting an ink composition to attach the ink composition onto the primer layer.

$$( 1 ) : Duty = ( number of actual printed dots ) / ( vertical resolution \times horizontal resolution ) \times 100$$

In the related art, it is known that a primer composition is attached to a recording medium in order to improve adhesion between the recording medium and an ink composition. As a result of repeated studies, the inventors of the present disclosure have found that when the primer composition is attached to the recording medium at a high duty, adhesion between the primer composition and the ink composition is improved, but surface roughness tends to be deteriorated. More specifically, in a case where the primer composition is attached to the recording medium at a high duty, unevenness is generated due to overlapping of dots of the primer composition on the recording medium, and roughness due to the unevenness of the primer composition is generated on the surface to which the ink composition is attached in this state. As a result, an image quality defect such as haze may occur on a surface of recorded matter. On the other hand, when the primer composition is attached to the recording medium at a low duty, it is difficult to obtain sufficient adhesion.

The ink jet recording method of the present embodiment includes the first ejection step of ejecting a primer composition from an ink jet head and attaching the primer composition to a recording medium so as to have a predetermined duty. By including such a first ejection step, adhesion between the primer composition and the ink composition is excellent, and surface roughness can be suppressed, that is, both adhesion and suppression of surface roughness can be achieved.

In the present specification, “duty” is a value calculated by the following formula (1), and means the amount of the primer composition attached to a pixel. Here, the duty of 5% to 50% means that the number of actual printed dots is 5% to 50% in a predetermined pixel (vertical resolution×horizontal resolution).

$$( 1 ) : Duty = ( number of actual printed dots ) / ( vertical resolution \times horizontal resolution ) \times 100$$

(In the formula (1), the “number of actual printed dots” is the number of actual printed dots per unit area, and the “vertical resolution” and the “horizontal resolution” are each resolution per unit area.)

### 1. 1. First ejection step

The ink jet recording method of the present embodiment includes the first ejection step of ejecting a primer composition from an ink jet head and attaching the primer composition to a recording medium such that a duty calculated by the following formula (1) is 5% to 50%.

$$( 1 ) : Duty = ( number of actual printed dots ) / ( vertical resolution \times horizontal resolution ) \times 100$$

The first ejection step is a step of discharging the primer composition from the ink jet head and attaching the primer composition to the recording medium so that the duty is 5% to 50%. More specifically, the primer composition filling a pressure generating chamber of the ink jet head is discharged from a nozzle by driving a pressure generating unit. Such an ejection method is also referred to as an ink jet method. When the duty is 5% or more, adhesion is excellent, and when the duty is 50% or less, overlapping of dots of the primer composition can be suppressed, and as a result, surface roughness can be suppressed. From the above viewpoint, the duty is preferably 6% to 45%, 7% to 40%, 8% to 35%, 9% to 30%, or 10% to 25%.

In the first ejection step, the recording resolution (vertical resolution×horizontal resolution) of the primer composition is not particularly limited, but is preferably 600×600 dpi or more, or 720×720 dpi or more. The upper limit of the recording resolution is not particularly limited, but is preferably 2400×2400 dpi or less, or 1440×1440 dpi or less. When the recording resolution of the primer composition is within the above ranges, both adhesion and suppression of surface roughness can be further achieved.

In the first ejection step, the weight of droplets of the primer composition is preferably 1 to 20 ng/dot, 2 to 18 ng/dot, 3 to 16 ng/dot, and 4 to 14 ng/dot. When the weight of droplets of the primer composition is within the above ranges, both adhesion and suppression of surface roughness can be further achieved.

Examples of the ink jet head used in the first ejection step include a line head that performs ejection by a line method and a serial head that performs ejection by a serial method.

In the line method using the line head, for example, an ink jet head having a width equal to or larger than a recording width of the recording medium is fixed to a recording apparatus. Then, when the recording medium is moved in a scanning manner along the transport direction, the primer composition can be attached onto the recording medium by discharging the primer composition from nozzles of the ink jet head.

In the serial method using the serial head, for example, the ink jet head is mounted on a carriage that can move in a width direction of the recording medium. Then, when the carriage is moved in a scanning manner in the width direction intersecting the transport direction of the recording medium, the primer composition can be attached onto the recording medium by discharging the primer composition from nozzles of the ink jet head.

In the first ejection step of the present embodiment, it is preferable that the primer composition be discharged by the serial method using the serial head from the viewpoint that the time from the discharge of the primer composition to the radiation irradiation in the first irradiation step described below can be secured, and both adhesion and suppression of surface roughness can be further achieved.

Here, “scanning” refers to moving the ink jet head relative to a recording region on the recording medium. In this case, scanning may be performed by moving the ink jet head with respect to the recording medium, or may be performed by moving the recording medium with respect to the ink jet head. Further, the relative positional relationship between the ink jet head and the recording medium may be changed by moving the positions of the ink jet head and the recording medium.

In addition, the ink jet head may be moved by moving the carriage, and also in this case, scanning is the movement of the ink jet head.

The recording medium used in the ink jet recording method of the present embodiment is not particularly limited, and examples thereof include an absorptive recording medium and a non-absorptive recording medium.

Examples of the absorptive recording medium include plain paper such as electrophotographic paper, ink jet paper, art paper, coated paper, and cast paper used for general offset printing.

Examples of the non-absorptive recording medium include plastics such as polyvinyl chloride (PVC), polystyrene (PS), polyethylene terephthalate (PET), polypropylene (PP), polyethylene (PE), polycarbonate, cellulose diacetate, cellulose triacetate, cellulose propionate, cellulose butyrate, cellulose acetate butyrate, cellulose nitrate, and polyvinyl acetal, and surface-treated products thereof, glass, metal, and wood.

The form of the recording medium is also not particularly limited, and examples thereof include a film, a board, and a cloth.

Among these recording media, the ink composition of the present embodiment which will be described later is preferably used for a non-absorptive recording medium, and a plastic film is particularly preferable. In particular, when polyethylene terephthalate (PET), polypropylene (PP), polyethylene (PE), polyvinyl chloride (PVC), polystyrene (PS), or polyolefin (PO) is used, adhesion between the recording medium and the primer composition and adhesion between the primer composition and the ink composition are more excellent. In particular, polyethylene terephthalate (PET), polypropylene (PP), and polyethylene (PE) are more preferable. In addition, when the recording medium is a shrink film which shrinks when heat or the like is applied, adhesion between the recording medium and the primer composition and adhesion between the primer composition and the ink composition are excellent, and processability of the recording medium is improved.

### 1. 2. First Irradiation Step

The ink jet recording method of the present embodiment includes a first irradiation step of curing the primer composition attached to the recording medium by radiation irradiation to form a primer layer.

The first irradiation step is a step of curing the primer composition attached to the recording medium by radiation irradiation to form a primer layer. When the primer composition is irradiated with radiation, a polymerization reaction of a monomer in the primer composition is initiated, and thus the primer composition is cured, and a primer layer is formed as a coating film. At this time, when a photopolymerization initiator is present, an active species (initiating species) such as a radical, an acid, or a base is generated, and the monomer polymerization reaction is promoted by the function of the initiating species. In addition, when a photosensitizer is present, the photosensitizer absorbs radiation and transits to an excited state, and when the photosensitizer comes into contact with the photopolymerization initiator, decomposition of the photopolymerization initiator is promoted, and thus a curing reaction can be further achieved.

Here, examples of the radiation include ultraviolet rays, infrared rays, visible rays, and X-rays, and among these, ultraviolet rays are preferable. A radiation source provided downstream of the ink jet head irradiates the primer composition with radiation.

In the first irradiation step, when the radiation is ultraviolet rays, the ultraviolet ray source is not particularly limited, and examples thereof include an ultraviolet light-emitting diode (LED). By using such an ultraviolet light source, device downsizing and cost reduction can be achieved. The ultraviolet light-emitting diode as the ultraviolet light source is small, and thus is attachable to an ink jet apparatus.

For example, the ultraviolet light-emitting diode can be attached to a carriage (each end along the recording medium width direction and/or the recording medium transport direction side) on which the ink jet head that ejects the ink composition is mounted. Furthermore, due to the composition of the primer composition described above, curing with low energy and at high speed can be achieved. The irradiation energy is calculated by multiplying irradiation time by irradiation intensity. Therefore, the irradiation time can be shortened, and printing speed is increased. On the other hand, the irradiation intensity can also be reduced. Consequently, increase in temperature of printed matter can be reduced, which leads to reduction of odor of a cured film.

The time from the ejection of the primer composition in the first ejection step to the radiation irradiation in the irradiation step is not particularly limited, but is preferably 5 seconds or more, and 10 seconds or more. The upper limit value is not particularly limited, but is preferably 120 seconds or less, 105 seconds or less, 90 seconds or less, or 60 seconds or less. When the time from the ejection of the primer composition in the first ejection step to the radiation irradiation in the irradiation step is 5 seconds or more, the surface of the ejected primer composition tends to be smoother, and as a result, surface roughness tends to be able to be suppressed. When the time from the ejection of the primer composition in the first ejection step to the radiation irradiation in the irradiation step is 120 seconds or less, production efficiency tends to be improved.

The thickness of the primer layer of the primer composition cured in the first irradiation step is not particularly limited, but is preferably 10 μm or less, or 5 μm or less.

### 1. 3. Second Ejection Step

The ink jet recording method of the present embodiment includes a second ejection step of ejecting the ink composition and attaching the ink composition onto the primer layer.

As a method of ejecting the ink composition in the second discharging step, the ink jet method described for the first ejection step is preferably performed. The ejection conditions in the second ejection step may be appropriately adjusted according to the physical properties of the ink composition.

The duty at the time of ejecting the ink composition in the second ejection step is not particularly limited, but is preferably 1% to 100%, 10% to 100%, 20% to 100%, 30% to 100%, or 40% to 100%, from the viewpoint of adhesion with the primer layer.

In the second ejection step, the recording resolution (vertical resolution×horizontal resolution) of the ink composition is not particularly limited, but is preferably 600×600 dpi or more, or 720×720 dpi or more. The upper limit of the recording resolution is not particularly limited, but is preferably 2400×2400 dpi or less, or 1440×1440 dpi or less. When the recording resolution of the ink composition is within the above ranges, adhesion with the primer layer tends to be more excellent.

In the second ejection step, the weight of droplets of the ink composition is preferably 1 to 20 ng/dot, 2 to 18 ng/dot, 3 to 16 ng/dot, or 4 to 14 ng/dot. When the weight of droplets of the ink composition is within the above ranges, adhesion with the primer layer tends to be more excellent.

### 1. 4. Other Steps

The ink jet recording method of the present embodiment may include other steps in addition to the first ejection step, the first irradiation step, and the second ejection step described above. Examples of the other steps include a second irradiation step and a winding step.

### 1. 4. 1. Second Irradiation Step

The ink jet recording method of the present embodiment may further include a second irradiation step of curing the ink composition attached onto the primer layer by radiation.

The second irradiation step is a step of curing the ink composition attached onto the primer layer by radiation irradiation. When the ink composition is irradiated with radiation, a polymerization reaction of a monomer in the ink composition is initiated, and thus the ink composition is cured to form a coating film. At this time, when a photopolymerization initiator is present, an active species (initiating species) such as a radical, an acid, or a base is generated, and the monomer polymerization reaction is promoted by the function of the initiating species. In addition, when a photosensitizer is present, the photosensitizer absorbs radiation and transits to an excited state, and when the photosensitizer comes into contact with the photopolymerization initiator, decomposition of the photopolymerization initiator is promoted, and thus a curing reaction can be further achieved.

As the radiation, those described in 1. 2. First irradiation step may be used, and ultraviolet rays are preferable.

The thickness of the coating film of the ink composition cured in the second irradiation step is not particularly limited, but is preferably 10 μm or less, or 5 μm or less.

### 1. 4. 2 Winding Step

The ink jet recording method of the present embodiment may further include a winding step of winding the recording medium to which the ink composition is attached.

In the winding step, the recording medium to which the ink composition is attached is wound into, for example, a roll shape by a winding device. The winding device is not particularly limited, and a known device such as a roller may be used. For example, recorded matter obtained by continuous recording on a long recording medium is wound into a roll shape on the downstream side of the recording apparatus so that the recorded matter is stacked with the recording surface and the non-recording surface facing each other. More specifically, the recorded matter can be formed into a wound body by winding the recorded matter with a winding roller. In the wound body, the recorded matter is wound while being stacked so that the recording surface and the non-recording surface face each other.

### 2. Primer Composition

The primer composition used in the ink jet recording method of the present embodiment is not particularly limited as long as it is a primer composition which is cured by radiation irradiation. Examples of the radiation include ultraviolet rays, infrared rays, visible light, and X-rays. Among these, as the radiation, ultraviolet rays are preferable from the viewpoints that a radiation source is easily available and widely used and that a material suitable for curing by ultraviolet ray irradiation is easily available and widely used.

The primer composition is not particularly limited and may contain, for example, a polymerizable compound, a photopolymerization initiator, a polymerization inhibitor, and the like. The primer composition of the present embodiment does not contain a coloring material, or the content of the coloring material in the primer composition is preferably 1% by mass or less, 0.5% by mass or less, 0.3% by mass or less, or 0.1% by mass or less with respect to the total amount of the primer composition. The lower limit of the content of the coloring material is not particularly limited, but is preferably as low as possible, and the coloring material may not be contained (0% by mass).

### 2. 1. Compound (A)

The primer composition of the present embodiment preferably contains at least one compound (A) selected from an ether ring-containing polymerizable compound (A-1) and a saturated hydrocarbon ring-containing polymerizable compound (A-2). In the case where the primer composition of the present embodiment includes the compound (A), adhesion between the primer layer and the ink composition tends to be excellent when the ink composition is attached to the primer layer.

The primer composition of the present embodiment preferably contains the ether ring-containing polymerizable compound (A-1) and the saturated hydrocarbon ring-containing polymerizable compound (A-2). When the ether ring-containing polymerizable compound (A-1) and the saturated hydrocarbon ring-containing polymerizable compound (A-2) are contained, the primer composition of the present embodiment tends to be able to suppress deterioration in adhesion due to a change over time or a high temperature. Although the mechanism thereof is not particularly limited, it is presumed that in the case where the two kinds of polymerizable compounds are contained: the ether ring-containing polymerizable compound (A-1) and the saturated hydrocarbon ring-containing polymerizable compound (A-2), compared to the case where one polymerizable compound of the ether ring-containing polymerizable compound (A-1) or the saturated hydrocarbon ring-containing polymerizable compound (A-2) is contained, monomers having different structures are polymerized, whereby shrinkage of the coating film is less likely to occur, and deterioration in adhesion due to a change over time or a high temperature is suppressed.

The content of the compound (A) is 85% by mass or more, preferably 90% by mass or more, 95% by mass or more, or 100% with respect to the total amount of the polymerizable compounds. When the content of the compound (A) is 85% by mass or more, adhesion with the ink composition tends to be more excellent.

### 2. 1. 1. Ether Ring-Containing Polymerizable Compound (A-1)

The ether ring-containing polymerizable compound (A-1) is not particularly limited as long as it is a polymerizable compound having an ether ring in the molecule thereof, and examples thereof include tetrahydrofurfuryl (meth)acrylate, γ-butyrolactone (meth)acrylate, dioxolane (meth)acrylate, dioxane glycol di(meth)acrylate, oxetane (meth)acrylate, (2-methyl-2-ethyl-1,3-dioxolane-4-yl) methyl acrylate (MEDOL-10), and cyclic trimethylolpropane formal (meth)acrylate, which may be used alone or in combination of two or more. Among these, as the ether ring-containing polymerizable compound (A-1), cyclic trimethylolpropane formal (meth)acrylate is preferable, and cyclic trimethylolpropane formal acrylate (CTFA) is more preferable. By using such a compound, adhesion with the ink composition tends to be more excellent.

The content of the ether ring-containing polymerizable compound (A-1) is preferably 5% by mass or more and 70% by mass or less, 10% by mass or more and 65% by mass or less, and 15% by mass or more and 60% by mass or less with respect to the total amount of the polymerizable compounds. When the content of the ether ring-containing polymerizable compound (A-1) is 5% by mass or more, adhesion with the ink composition tends to be more excellent, and when the content is 70% by mass or less, deterioration in adhesion due to a change over time or a high temperature tends to be able to be suppressed.

### 2. 1. 2. Saturated Hydrocarbon Ring-Containing Polymerizable Compound (A-2)

The saturated hydrocarbon ring-containing polymerizable compound (A-2) is not particularly limited as long as it is a polymerizable compound having a saturated hydrocarbon ring in the molecule thereof, and examples thereof include isobornyl methacrylate, isobornyl acrylate (IBXA), tert-butylcyclohexanol acrylate (TBCHA), and 2-(meth)acrylic acid-1,4-dioxaspiro[4.5]dec-2-ylmethyl, which may be used alone or in combination of two or more. Among these, tert-butyl cyclohexanol acrylate (TBCHA) is preferable as the saturated hydrocarbon ring-containing polymerizable compound (A-2). By using such a compound, adhesion with the ink composition tends to be more excellent. In particular, although adhesion may decrease over time, by using the saturated hydrocarbon ring-containing polymerizable compound (A-2) as described above, a decrease in adhesion over time can be suppressed.

The content of the saturated hydrocarbon ring-containing polymerizable compound (A-2) is preferably 20% by mass or more and 95% by mass or less, 25% by mass or more and 92% by mass or less, 30% by mass or more and 88% by mass or less, or 38% by mass or more and 85% by mass or less with respect to the total amount of the polymerizable compounds. When the content of the saturated hydrocarbon ring-containing polymerizable compound (A-2) is 20% by mass or more, adhesion with the ink composition tends to be more excellent, and when the content is 95% by mass or less, deterioration in adhesion due to a change over time or a high temperature tends to be able to be suppressed.

### 2. 2. Other Polymerizable Compounds

The primer composition of the present embodiment may contain another polymerizable compound as the polymerizable compound. The other polymerizable compound is not particularly limited, and may be a monofunctional monomer having one polymerizable functional group or a polyfunctional monomer having a plurality of polymerizable functional groups. The other polymerizable compound may include an oligomer having one or two or more polymerizable functional groups. One kind of the polymerizable compounds may be used alone, or two or more kinds thereof may be used in combination.

The other polymerizable compound is not particularly limited, and a heretofore known monomer having a polymerizable functional group, particularly a polymerizable functional group having a carbon-carbon unsaturated double bond, can be used. Examples thereof include an aromatic ring-containing monomer, a nitrogen-containing heterocycle-containing monomer, a non-alicyclic aliphatic group-containing monomer, and a hydroxy group-containing monomer. Among these, as the other monomer, an aromatic ring-containing monomer and/or a nitrogen-containing heterocycle-containing monomer is preferably contained.

### 2. 2. 1. Aromatic Ring-Containing Monomer

The aromatic ring-containing monomer is not particularly limited, and examples thereof include phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, p-cumylphenol EO-modified (meth)acrylate, and 2-hydroxy-3-phenoxypropyl (meth)acrylate, which may be used alone or in combination of two or more. Among these, benzyl (meth)acrylate is preferably contained as the aromatic ring-containing monomer, and benzyl acrylate (BZA) is more preferably contained.

In the case of containing the aromatic ring-containing monomer, the content of the aromatic ring-containing monomer is preferably 1% by mass or more and 20% by mass or less, 3% by mass or more and 15% by mass or less, or 5% by mass or more and 10% by mass or less with respect to the total amount of the polymerizable compounds. When the content of the aromatic ring-containing monomer is within the above ranges, adhesion tends to be excellent.

### 2. 2. 2. Nitrogen-Containing Heterocycle-Containing Monomer

The nitrogen-containing heterocycle-containing monomer is not particularly limited, and examples thereof include vinylmethyloxazolidinone (VMOX), N-vinylcaprolactam, N-vinylcarbazole, N-vinylpyrrolidone, and acryloylmorpholine (ACMO), which may be used alone or in combination of two or more. Among these, acryloylmorpholine (ACMO) is more preferably contained as the nitrogen-containing heterocycle-containing monomer.

In the case where the nitrogen-containing heterocycle-containing monomer is contained, the content of the nitrogen-containing heterocycle-containing monomer is preferably 1% by mass or more and 20% by mass or less, 3% by mass or more and 15% by mass or less, or 5% by mass or more and 10% by mass or less with respect to the total amount of the polymerizable compounds. When the content of the nitrogen-containing heterocycle-containing monomer is within the above ranges, adhesion tends to be excellent.

### 2. 2. 3. Oligomer

The oligomer is a multimer containing a polymerizable compound as a constituent, and refers to a compound having one or two or more polymerizable functional groups. The polymerizable compound herein is not limited to the above-described monofunctional monomer and polyfunctional monomer. In the present embodiment, a compound having a molecular weight of 1000 or greater is defined as an oligomer, and a compound having a molecular weight of less than 1000 is defined as a monomer.

Such an oligomer is not particularly limited, and examples thereof include a urethane acrylate oligomer having a urethane repeating structure, a polyester acrylate oligomer having an ester repeating structure, and an epoxy acrylate oligomer having an epoxy repeating structure.

Among these, a urethane acrylate oligomer is preferable, an aliphatic urethane acrylate oligomer and an aromatic urethane acrylate oligomer are more preferable, and an aliphatic urethane acrylate oligomer is still more preferable. The urethane acrylate oligomer is preferably a urethane acrylate oligomer having four or less functional groups, and more preferably a urethane acrylate oligomer having two functional groups. By using such an oligomer, the viscosity tends to be further decreased, and abrasion resistance and the like tend to be further improved.

When the oligomer is used, the content thereof is preferably 0% to 10% by mass, 0.5% to 5% by mass, or 1% to 3% by mass with respect to the total amount of the composition. When the content of the oligomer is within the above ranges, the viscosity tends to be further decreased, and abrasion resistance and the like tend to be further improved.

### 2. 3. Photopolymerization Initiator

The primer composition of the present embodiment may further contain a photopolymerization initiator. The photopolymerization initiator may be used alone or in combination of two or more kinds thereof.

The photopolymerization initiator is not particularly limited as long as it generates an active species by radiation irradiation, and examples thereof include known photopolymerization initiators such as an acylphosphine oxide-based photopolymerization initiator, an alkylphenone-based photopolymerization initiator, a titanocene-based photopolymerization initiator, and a thioxanthone-based photopolymerization initiator. Among these, the photopolymerization initiator preferably includes an acylphosphine oxide-based photopolymerization initiator and/or a thioxanthone-based photopolymerization initiator, and more preferably includes an acylphosphine oxide-based photopolymerization initiator and a thioxanthone-based photopolymerization initiator. By using such a photopolymerization initiator, curability of the primer composition tends to be further improved, and adhesion tends to be excellent.

The acylphosphine oxide-based photopolymerization initiator is not particularly limited, and examples thereof include 2,4,6-trimethylbenzoyl diphenyl phosphineoxide, bis(2,4,6-trimethylbenzoyl)-phenyl phosphineoxide, bis-(2,6-dimethoxybenzoyl)-2,4,4-trimethylpentyl phosphineoxide, and ethyl phenyl(2,4,6-trimethylbenzoyl) phosphinate.

Examples of commercially available products of the acylphosphine oxide-based photopolymerization initiator include IRGACURE 819 (bis(2,4,6-trimethylbenzoyl)-phenylphosphineoxide), IRGACURE 1800 (a mixture of bis-(2,6-dimethoxybenzoyl)-2,4,4-trimethylpentylphosphineoxide and 1-hydroxy-cyclohexyl-phenylketone at a weight ratio of 25:75), IRGACURE TPO (2,4,6-trimethylbenzoyldiphenylphosphineoxide), and IRGACURE TPO-L (ethyl phenyl(2,4,6-trimethylbenzoyl) phosphinate) (all manufactured by BASF SE).

The thioxanthone-based photopolymerization initiator is not particularly limited, and examples thereof include thioxanthone, 2-methylthioxanthone, 2,4-diethylthioxanthone, 2-isopropylthioxanthone, 4-isopropylthioxanthone, 2-chlorothioxanthone, and 2,4-diethylthioxanthone. In addition, thioxanthone-based photopolymerization initiators having a molecular weight of 500 or more, such as 1,3-di({α-[1-chloro-9-oxo-9H-thioxanthen-4-yl)oxy]acetylpoly[oxy(1-methylethylene)]} oxy)-2,2-bis({α-[1-chloro-9-oxo-9H-thioxanthen-4-yl)oxy]acetylpoly[oxy(1-methylethylene)]}oxymethyl)propane (CAS registry number: No. 1003567-83-6) and α-[2-[(9-oxo-9H-thioxanthenyl)oxy]acetyl]-ω-[2-[(9-oxo-9H-thioxanthenyl)oxy]acetyl]oxy]poly(oxy-1,4-butanediyl (CAS registry number: No. 813452-37-8) are also included. These photopolymerization initiators are preferable from the viewpoint that odors of a coating film can be reduced.

Examples of commercially available products of the thioxanthone-based photopolymerization initiator include KAYACURE DETX-S (2,4-diethylthioxanthone, trade name, manufactured by Nippon Kayaku Co., Ltd.), Speedcure DETX (2,4-diethylthioxanthone, trade name, manufactured by Lambson Ltd.), and KAYACURE ITX (2-/4-isopropylthioxanthone, trade name, manufactured by Nippon Kayaku Co., Ltd.).

The content of the photopolymerization initiator is not particularly limited, but is preferably 1% by mass or more, 3% by mass or more, 4% by mass or more, or 5% by mass or more with respect to the total amount of the primer composition. The upper limit of the content of the photopolymerization initiator is not particularly limited, and may be 15% by mass or less. When the content of the photopolymerization initiator is within the above ranges, curability of the primer composition tends to be further improved, and adhesion tends to be excellent.

When the acylphosphine oxide-based photopolymerization initiator is contained as the photopolymerization initiator, the content thereof is preferably 1% by mass or more and 15% by mass or less, 2% by mass or more and 10% by mass or less, 3% by mass or more and 8% by mass or less, or 5% by mass or more and 7% by mass or less with respect to the total amount of the primer composition. When the content of the acylphosphine oxide-based photopolymerization initiator is within the above ranges, curability of the primer composition tends to be further improved, and adhesion tends to be excellent.

In the case where the thioxanthone-based photopolymerization initiator is contained as the photopolymerization initiator, the content thereof is preferably 0.1% by mass or more and 10% by mass or less, 0.2% by mass or more and 5% by mass or less, 0.3% by mass or more and 3% by mass or less, or 0.5% by mass or more and 2.5% by mass or less with respect to the total amount of the primer composition. When the content of the thioxanthone-based photopolymerization initiator is within the above ranges, curability of the primer composition tends to be further improved, and adhesion tends to be excellent.

### 2. 4. Polymerization Inhibitor

The primer composition of the present embodiment may further contain a polymerization inhibitor. One kind of the polymerization inhibitor may be used alone, or two or more kinds thereof may be used in combination.

Examples of the polymerization inhibitor include, but are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol), bis(2,2,6,6-tetramethyl-4-piperidyl-1-oxyl)sebacate (BisTEMPO sebacate), and a hindered amine compound.

The content of the polymerization inhibitor is preferably 0.05% to 1% by mass and more preferably 0.05% to 0.5% by mass with respect to the total amount of the ink composition.

### 2. 5. Other Additives

The primer composition of the present embodiment may contain other additives as long as effects of the present embodiment are not impaired. As other additives, for example, various known additives such as a viscosity modifier, an antioxidant, an ultraviolet absorber, a rust inhibitor, a corrosion inhibitor, and a chelating agent may be contained.

Examples of the surfactant include, but are not limited to, an acetylene glycol-based surfactant, a fluorine-based surfactant, and a silicone-based surfactant. These surfactants are used singly or in combination of two or more kinds.

The silicone-based surfactant is not particularly limited, and examples thereof include a polysiloxane-based compound and a polyether modified organosiloxane.

The content of the surfactant is preferably 1.0% by mass or less, 0.80% by mass or less, or 0.60% by mass or less with respect to the total amount of the primer composition. The lower limit of the content of the surfactant is not particularly limited, and may be 0% by mass or more. When the content of the surfactant is within the above ranges, wettability to the recording medium tends to be improved, and surface roughness tends to be able to be suppressed.

### 3. Ink Composition

The ink composition used in the ink jet recording method of the present embodiment is not particularly limited as long as it is an ink composition which is cured by radiation irradiation. Examples of the radiation include ultraviolet rays, infrared rays, visible light, and X-rays. Among these, as the radiation, ultraviolet rays are preferable from the viewpoints that a radiation source is easily available and widely used and that a material suitable for curing by ultraviolet ray irradiation is easily available and widely used.

The ink composition is not particularly limited and may contain, for example, a polymerizable compound, a photopolymerization initiator, a polymerization inhibitor, and the like. The polymerizable compound is not particularly limited, and may be a monofunctional monomer having one polymerizable functional group, a polyfunctional monomer having a plurality of polymerizable functional groups, or an oligomer. One kind of the polymerizable compounds may be used alone, or two or more kinds thereof may be used in combination.

### 3. 1. Monofunctional Monomer

The monofunctional monomer is not particularly limited, and examples thereof include the above-described compound (A), an aromatic ring-containing monomer, a nitrogen-containing heterocycle-containing monomer, a linear or branched aliphatic group-containing monomer, and a hydroxyl group-containing monomer.

The content of the monofunctional monomer is not particularly limited, but is preferably 60% by mass or more, 65% by mass or more, 70% by mass or more, and 75% by mass or more with respect to the total amount of the polymerizable compound. The upper limit of the content of the monofunctional monomer is not particularly limited, and may be 95% by mass or less, 90% by mass or less, or 85% by mass or less. When the content of the monofunctional monomer is within the above ranges, a flexible cured product is obtained when the ink composition is cured, and the ink composition tends to have high adhesion even to a thin and flexible recording medium.

The content of the monofunctional monomer is not particularly limited, but is preferably 30% by mass or more, 40% by mass or more, 50% by mass or more, or 60% by mass or more with respect to the total amount of the ink composition. The upper limit of the content of the monofunctional monomer is not particularly limited, and may be 90% by mass or less. When the content of the monofunctional monomer is within the above ranges, a flexible cured product is obtained when the ink composition is cured, and the ink composition tends to have high adhesion even to a thin and flexible recording medium.

### 3. 1. 1. Compound (A)

As the compound (A) contained in the ink composition, the ether ring-containing polymerizable compound (A-1) and the saturated hydrocarbon ring-containing polymerizable compound (A-2) exemplified for the primer composition can be used. The compound (A) contained in the ink composition and the compound (A) contained in the primer composition may be the same or different. When the compound (A) contained in the ink composition and the compound (A) contained in the primer composition coincide with each other, compatibility between the ink and the primer is more preferable, and adhesion with the primer composition tends to be more excellent.

The content of the compound (A) is not particularly limited, but is preferably 1% by mass or more, 5% by mass or more, and preferably 10% by mass or more with respect to the total amount of the polymerizable compounds. The upper limit of the content of the compound (A) is not particularly limited, and is preferably 35% by mass or less, 30% by mass or less, or 25% by mass or less. When the content of the compound (A) is within the above ranges, adhesion with the primer layer tends to be excellent.

### 3. 1. 2. Aromatic Ring-Containing Monomer

The aromatic ring-containing monomer is not particularly limited, and for example, the above-described aromatic ring-containing monomers can be used. Among the aromatic ring-containing monomers described above, the ink composition of the present embodiment preferably contains phenoxyethyl (meth)acrylate or benzyl acrylate, and more preferably contains phenoxyethyl acrylate (PEA). By using such an aromatic ring-containing monomer, adhesion with the primer layer and curability tend to be excellent.

The content of the aromatic ring-containing monomer is not particularly limited, and is preferably 10% by mass or more and 65% by mass or less, 15% by mass or more and 60% by mass or less, 20% by mass or more and 55% by mass or less, or 25% by mass or more and 50% by mass or less with respect to the total amount of the polymerizable compounds. When the content of the aromatic ring-containing monomer is within the above ranges, adhesion with the primer layer tends to be excellent.

### 3. 1. 3. Hydroxy Group-Containing Monomer

The hydroxy group-containing monomer is not particularly limited, and examples thereof include hydroxyalkyl methacrylates such as 2-hydroxyethyl (meth)acrylate, 2-hydroxypropyl (meth)acrylate, 3-hydroxypropyl (meth)acrylate, 3-hydroxybutyl (meth)acrylate, and 4-hydroxybutyl (meth)acrylate. Among these, the ink composition of the present embodiment preferably contains 4-hydroxybutyl (meth)acrylate, and more preferably contains 4-hydroxybutyl acrylate (4-HBA). By using such a hydroxyl group-containing monomer, adhesion with the primer layer tends to be excellent.

The content of the hydroxy group-containing monomer is not particularly limited, and is preferably 1% by mass or more and 50% by mass or less, 3% by mass or more and 40% by mass or less, 5% by mass or more and 30% by mass or less, or 7% by mass or more and 20% by mass or less with respect to the total amount of the polymerizable compounds. When the content of the hydroxy group-containing monomer is within the above ranges, adhesion with the primer layer tends to be excellent.

### 3. 2. Multifunctional Monomer

The ink composition of the present embodiment may further contain a polyfunctional monomer. Examples of the polyfunctional monomer include, but are not limited to, a vinyl ether group-containing (meth)acrylate and a polyfunctional (meth)acrylate.

The content of the polyfunctional monomer is not particularly limited, but is preferably 80% by mass or less, 60% by mass or less, 50% by mass or less, or 40% by mass or less with respect to the total amount of the polymerizable compounds. The lower limit of the content of the polyfunctional monomer is not particularly limited, and may be 10% by mass or more, 20% by mass or more, or 30% by mass or more. When the content of the polyfunctional monomer is within the above-described ranges, a flexible cured product with sufficient curability is obtained when the ink composition is cured, and the ink composition tends to have high adhesion even to a thin and flexible recording medium.

### 3. 2. 1. Vinyl Ether Group-Containing (Meth)Acrylate

The vinyl ether group-containing (meth)acrylate is not particularly limited, and examples thereof include a compound represented by the following formula (1). When such a vinyl ether group-containing (meth)acrylate is contained, the viscosity of the composition decreases, and ejection stability tends to be further improved. In addition, curability of the composition is further improved, and along with improvement of curability, recording speed can be further increased.

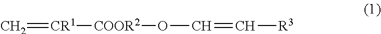

(In the formula, R¹ is a hydrogen atom or a methyl group, R² is a divalent organic residue having 2 to 20 carbon atoms, and R³ is a hydrogen atom or a monovalent organic residue having 1 to 11 carbon atoms.)

In the above formula (1), examples of the divalent organic residue having 2 to 20 carbon atoms represented by R² include a linear, branched, or cyclic alkylene group having 2 to 20 carbon atoms, which may be substituted; an alkylene group having 2 to 20 carbon atoms and having an oxygen atom through an ether bond and/or an ester bond in the structure, which may be substituted; and a divalent aromatic group having 6 to 11 carbon atoms, which may be substituted. Among these, an alkylene group having 2 to 6 carbon atoms such as an ethylene group, an n-propylene group, an isopropylene group, and a butylene group, and an alkylene group having 2 to 9 carbon atoms and having an oxygen atom through an ether bond in the structure such as an oxyethylene group, an oxy-n-propylene group, an oxyisopropylene group, and an oxybutylene group are preferable. Furthermore, from the viewpoints that the viscosity of the composition can be further reduced and curability of the composition is further improved, a compound having a glycol ether chain in which R² is an alkylene group having 2 to 9 carbon atoms and having an oxygen atom through an ether bond in the structure, such as an oxyethylene group, an oxy-n-propylene group, an oxyisopropylene group, or an oxybutylene group, is more preferable.

In the above formula (1), as the monovalent organic residue having 1 to 11 carbons represented by R³, a linear, branched, or cyclic alkyl group having 1 to 10 carbon atoms, which may be substituted, and an aromatic group having 6 to 11 carbon atoms, which may be substituted, are preferable. Among these, an alkyl group having 1 or 2 carbon atoms, which is a methyl group or an ethyl group, and an aromatic group having 6 to 8 carbon atoms, such as a phenyl group and a benzyl group, are preferably used.

In the case where each of the above-described organic residues is a group which may be substituted, substituents thereof are divided into a group that contains a carbon atom and a group that contains no carbon atom. First, in the case of a substituent that is a group containing a carbon atom, the carbon atom is counted as the number of carbon atoms of the organic residue. Although the group containing a carbon atom is not limited to the following groups, examples thereof include a carboxy group and an alkoxy group. Next, although the group that contains no carbon atom is not limited to the following groups, examples thereof include a hydroxy group and a halogen group.

Specific examples of the compound of formula (1) include, but are not particularly limited to, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(2-vinyloxyethoxy)ethyl acrylate (VEEA), 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. Among these specific examples, 2-(2-vinyloxyethoxy) ethyl acrylate (VEEA) is particularly preferable in that the curability and the viscosity of the ink composition are easily balanced.

The content of the vinyl ether group-containing (meth)acrylate is preferably 0.1% to 30% by mass, 1% to 20% by mass, and 3% to 10% by mass with respect to the total amount of the polymerizable compounds. When the content of the vinyl ether group-containing (meth)acrylate is within the above ranges, storage stability of the ink composition tends to be excellent, the viscosity of the composition tends to decrease, and ejection stability tends to be further improved.

### 3. 2. 2. Polyfunctional (Meth)Acrylate

The polyfunctional (meth)acrylate is not particularly limited, and examples thereof include bifunctional (meth)acrylates such as dipropylene glycol diacrylate (DPGDA), diethylene glycol di(meth)acrylate, triethylene glycol di(meth)acrylate, tetraethylene glycol di(meth)acrylate, polyethylene glycol di(meth)acrylate, dipropylene glycol dimethacrylate, tripropylene glycol di(meth)acrylate (TPGDA), polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-ethylene oxide (EO) adduct di(meth)acrylate, bisphenol A-propylene oxide (PO) adduct di(meth)acrylate, hydroxypivalic acid neopentyl glycol di(meth)acrylate, and polytetramethylene glycol di(meth)acrylate; and polyfunctional (meth)acrylates having three or more functional groups such as trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate (ADPH), ditrimethylolpropane tetra(meth)acrylate, glyceryl propoxy tri(meth)acrylate, caprolactone-modified trimethylolpropane tri(meth)acrylate, pentaerythritol ethoxy tetra(meth)acrylate, and caprolactam-modified dipentaerythritol hexa(meth)acrylate. Among these specific examples, dipropylene glycol diacrylate (DPGDA) is particularly preferable from the viewpoint of more excellent adhesion with the primer layer.

The content of the polyfunctional (meth)acrylate is preferably 1% to 50% by mass, 2% to 30% by mass, 3% to 20% by mass, or 5% to 15% by mass with respect to the total amount of the polymerizable compound. When the content of the polyfunctional (meth)acrylate is within the above ranges, adhesion with the primer layer tends to be more excellent.

### 3. 3. Oligomer

The ink composition of the present embodiment may contain an oligomer as the polymerizable compound.

The oligomer is not particularly limited, and examples thereof include a urethane acrylate oligomer having a urethane repeating structure, a polyester acrylate oligomer having an ester repeating structure, and an epoxy acrylate oligomer having an epoxy repeating structure.

Among these, a urethane acrylate oligomer is preferable, an aliphatic urethane acrylate oligomer and an aromatic urethane acrylate oligomer are more preferable, and an aliphatic urethane acrylate oligomer is still more preferable. The urethane acrylate oligomer is preferably a urethane acrylate oligomer having four or less functional groups, and more preferably a urethane acrylate oligomer having two functional groups. By using such an oligomer, the viscosity of the ink composition tends to be further decreased, and abrasion resistance and the like tend to be further improved.

The content of the oligomer in the case of using the oligomer is preferably from 0% to 10% by mass, from 0.5% to 5% by mass, or from 1% to 3% by mass with respect to the total amount of the polymerizable compound. When the content of the oligomer is within the above ranges, the viscosity of the ink composition tends to be further decreased, and abrasion resistance and the like tend to be further improved.

### 3. 4. Photopolymerization Initiator

The ink composition of the present embodiment preferably further contains a photopolymerization initiator. The photopolymerization initiator is not particularly limited, and for example, those described in “2. 3. Photopolymerization initiator” can be used. Among these, the photopolymerization initiator preferably includes an acylphosphine oxide-based photopolymerization initiator and/or a thioxanthone-based photopolymerization initiator, and more preferably includes an acylphosphine oxide-based photopolymerization initiator and a thioxanthone-based photopolymerization initiator. By using such a photopolymerization initiator, curability of the ink composition tends to be further improved, and adhesion with the primer layer tends to be excellent.

The content of the photopolymerization initiator is not particularly limited, but is preferably 1% by mass or more, 5% by mass or more, 10% by mass or more, or 12% by mass or more with respect to the total amount of the ink composition. The upper limit of the content of the photopolymerization initiator is not particularly limited, and may be 20% by mass or less. When the content of the photopolymerization initiator is within the above ranges, curability of the ink composition tends to be further improved, and adhesion with the primer layer tends to be excellent.

In the case where the acylphosphine oxide-based photopolymerization initiator is contained as the photopolymerization initiator, the content thereof is preferably 2% by mass or more and 18% by mass or less, 4% by mass or more and 16% by mass or less, or 5% by mass or more and 12% by mass or less with respect to the total amount of the ink composition. When the content of the acylphosphine oxide-based photopolymerization initiator is within the above ranges, curability of the ink composition tends to be further improved, and adhesion with the primer layer tends to be excellent.

In the case where the thioxanthone-based photopolymerization initiator is contained as the photopolymerization initiator, the content thereof is preferably 0.5% by mass or more and 8% by mass or less, 1% by mass or more and 7% by mass or less, 2% by mass or more and 6% by mass or less, or 3% by mass or more and 5% by mass or less with respect to the total amount of the ink composition. When the content of the thioxanthone-based photopolymerization initiator is within the above ranges, curability of the ink composition tends to be further improved, and adhesion with the primer layer tends to be excellent.

### 3. 5. Other Additives

The ink composition of the present embodiment may contain other additives as long as effects of the present embodiment are not impaired. For example, various heretofore known additives such as a polymerization inhibitor, a surfactant, a dispersant, a coloring material, and a fluorescent brightener may be contained.

### 3. 5. 1. Polymerization Inhibitor

The primer composition of the present embodiment may further contain a polymerization inhibitor. One kind of the polymerization inhibitor may be used alone, or two or more kinds thereof may be used in combination.

Examples of the polymerization inhibitor include, but are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), and 4,4′-thiobis(3-methyl-6-t-butylphenol), bis(2,2,6,6-tetramethyl-4-piperidyl-1-oxyl)sebacate (BisTEMPO sebacate), and a hindered amine compound.

The content of the polymerization inhibitor is preferably 0.05% to 1% by mass and more preferably 0.05% to 0.5% by mass with respect to the total amount of the ink composition.

### 3. 5. 2. Surfactant

The ink composition according to the present embodiment may further include a surfactant. One kind of the surfactant may be used alone, or two or more kinds thereof may be used in combination.

The surfactant is preferably a silicone-based surfactant, and more preferably polyester-modified silicone or polyether-modified silicone. Examples of the polyester-modified silicone include BYK-347, 348, BYK-UV3500, 3510, and 3530 (all manufactured by BYK Additives & Instruments), and examples of the polyether-modified silicone include BYK-3570 (manufactured by BYK Additives & Instruments).

The content of the surfactant is preferably 0.01% to 2% by mass and more preferably 0.05% to 1% by mass with respect to the total amount of the ink composition.

### 3. 5. 3. Dispersant

The ink composition of the present embodiment may further contain a dispersant in order to further improve dispersibility of a coloring material and the like. One kind of the dispersant may be used alone, or two or more kinds thereof may be used in combination.

The dispersant is not particularly limited, and examples thereof include dispersants that are commonly used to prepare a pigment dispersion liquid, such as a polymer dispersant. Specific examples thereof include those containing, as a main component, one or more of a polyoxyalkylene polyalkylene polyamine, a vinyl-based polymer and copolymer, an acrylic polymer and copolymer, polyester, polyamide, polyimide, polyurethane, an amino-based polymer, a silicon-containing polymer, a sulfur-containing polymer, a fluorine-containing polymer, and an epoxy resin.

Examples of commercially available products of the polymer dispersant include AJISPER series manufactured by Ajinomoto Fine-Techno Co., Inc., Solsperse series (Solsperse 36000 and the like) available from Avecia or Noveon Inc, DISPERBYK series manufactured by BYK Additives & Instruments, and DISPARLON series manufactured by Kusumoto Chemicals, Ltd.

The content of the dispersant is preferably 0.1% to 2% by mass, 0.1% to 1.5% by mass, or 0.1% to 1.0% by mass with respect to the total amount of the ink composition.

### 3. 5. 4. Coloring Material

The ink composition of the present embodiment may further contain a coloring material. One kind of the coloring material may be used alone, or two or more kinds thereof may be used in combination.

The coloring material is not particularly limited, and examples thereof include pigments and dyes. One kind of the coloring material may be used alone, or two or more kinds thereof may be used in combination.

The content of the coloring material is preferably 0.5% to 15.0% by mass, more preferably 1.0% to 10.0% by mass, and still more preferably 1.5% to 7.0% by mass with respect to the total amount of the ink composition. When the content of the coloring material is within the above ranges, color developability tends to be further improved.

The ink composition of the present embodiment may contain a pigment as the coloring material. The pigment is not particularly limited, and organic pigments such as an azo pigment (including azo lake, an insoluble azo pigment, a condensed azo pigment, and a chelate azo pigment, for example), a polycyclic pigment (such as a phthalocyanine pigment, a perylene pigment, a perinone pigment, an anthraquinone pigment, a quinacridone pigment, a dioxazine pigment, a thioindigo pigment, an isoindolinone pigment, and a quinophthalone pigment), a nitro pigment, a nitroso pigment, and aniline black; and inorganic pigments such as carbon black (for example, furnace black, thermal lamp black, acetylene black, and channel black), a metal oxide, a metal sulfide, and a metal chloride; and extender pigments such as calcium carbonate and talc can be used, for example.

The pigment may be added to the ink composition in the form of a pigment dispersion liquid obtained by dispersing the pigment in water with a dispersant, or in the form of a pigment dispersion liquid obtained by dispersing in water a self-dispersible surface-treated pigment (hereinafter also referred to as a “self-dispersible pigment”) in which a hydrophilic group has been introduced onto the pigment particle surface using a chemical reaction, or by dispersing in water a pigment coated with a polymer (hereinafter also referred to as a “resin-dispersed pigment”). Among these, a self-dispersible pigment is preferably contained. By using the self-dispersible pigment, water repellency of a nozzle plate and intermittent printing stability tend to be further improved.

One kind of each of the pigment and the dispersant constituting the pigment dispersion liquid may be used alone, or two or more kinds thereof may be used in combination.

The ink composition of the present embodiment may contain a dye as the coloring material. The dye is not particularly limited, and examples thereof include acid dyes such as C.I. Acid Yellow, C.I. Acid Red, C.I. Acid Blue, C.I. Acid Orange, C.I. Acid Violet, and C.I. Acid Black; basic dyes such as C.I. Basic Yellow, C.I. Basic Red, C.I. Basic Blue, C.I. Basic Orange, C.I. Basic Violet, and C.I. Basic Black; direct dyes such as C.I. Direct Yellow, C.I. Direct Red, C.I. Direct Blue, C.I. Direct Orange, C.I. Direct Violet, and C.I. Direct Black; reactive dyes such as C.I. Reactive Yellow, C.I. Reactive Red, C.I. Reactive Blue, C.I. Reactive Orange, C.I. Reactive Violet, and C.I. Reactive Black; and disperse dyes sch as C.I. Disperse Yellow, C.I. Disperse Red, C.I. Disperse Blue, C.I. Disperse Orange, C.I. Disperse Violet, and C.I. Disperse Black. One kind of the dye may be used alone, or two or more kinds thereof may be used in combination.

### 3. 5. 5. Fluorescent Brightener

The ink composition of the present embodiment may further contain a fluorescent brightener. One kind of the fluorescent brightener may be used alone, or two or more kinds thereof may be used in combination.

Fluorescent brighteners absorb light at wavelengths around 300 nm to 450 nm and emit fluorescence at wavelengths around 400 nm to 500 nm, for example. That is, when ultraviolet rays are used as radiation, the fluorescent brightener increases a long wavelength region of the ultraviolet rays with which ink is irradiated, thereby improving curability. Since the combination of a fluorescent brightener and a photoinitiator exhibits a sensitizing effect, inclusion of the fluorescent brightener tends to result in more excellent curability than the case of including only a photoinitiator.

Examples of the fluorescent brightener include a naphthalenebenzoxazolyl derivative, a thiophene benzoxazolyl derivative, a stilbene benzoxazolyl derivative, a coumarin derivative, a styrene biphenyl derivative, a pyrazolone derivative, a stilbene derivative, styryl derivatives of benzene and biphenyl, a bis(benzazol-2-yl) derivative, carbostyril, naphthalimide, a derivative of dibenzothiophene-5,5′-dioxide, a pyrene derivative, and a pyridotriazole and the like.

A commercially available product may be used as the fluorescent brightener. Examples of commercially available products include TELALUX (registered trademark) OB (2,5-bis(5-tert-butyl-2-benzoxazolyl)thiophen) and KCB (1,4-bis(2-benzoxazolyl)naphthalene) available from Clariant Japan K. K.

The content of the fluorescent brightener contained in the ink composition is preferably 0.07% to 0.70% by mass or less and 0.10% to 0.50% by mass or less with respect to the total amount of the ink composition. When the content of the fluorescent brightener is within the above ranges, curability of the ink composition tends to be improved.

### 4. Ink Jet Recording Apparatus

The ink jet recording apparatus according to the present embodiment includes an ink jet head which ejects a liquid by an ink jet method and causes the liquid to be attached to a recording medium, and a control section which controls the ejection of the liquid, and the control section executes a first ejection step of ejecting a primer composition by an ink jet method and causing the primer composition to be attached to the recording medium so that the duty is 5% to 50%.

The ink jet recording apparatus according to the present embodiment may include a radiation source which irradiates the primer composition attached to the recording medium with radiation.

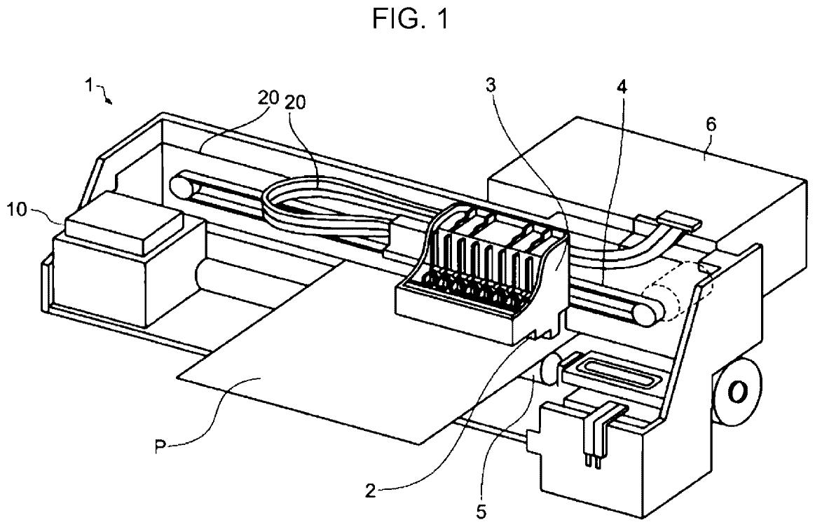

FIG. 1 is a perspective view showing a configuration of the recording apparatus in the present embodiment. The recording apparatus 1 shown in FIG. 1 is a so-called serial printer in which the primer composition is ejected when the ink jet head is moved in a scanning manner in the width direction intersecting the transport direction of the recording medium, but the recording apparatus in the present embodiment may be a line printer in which the primer composition is ejected from a nozzle of the ink jet head when the recording medium is moved in a scanning manner along the transport direction.

As shown in FIG. 1, the recording apparatus 1 includes a carriage 3 on which an ink jet head 2 is mounted, a carriage moving mechanism 4 that moves the carriage 3 in a recording medium width direction of a recording medium P, and a medium feeding mechanism 5 that transports the recording medium P in a recording medium feeding direction. In addition, the recording apparatus 1 also includes a control section 6 that controls the overall operation of the recording apparatus 1. The above-described recording medium width direction is the main scanning direction (head scanning direction). The above-described medium feeding direction is the sub-scanning direction (a direction orthogonal to the main scanning direction).

As the recording apparatus 1 according to the present embodiment, a so-called off-carriage type printer in which an ink accommodating section 10 is mounted on a housing or the like of the recording apparatus 1 and ink is supplied to the ink jet head 2 via an ink supply tube 20 is exemplified; however, the present disclosure is not limited thereto. For example, a so-called on-carriage type printer in which an ink cartridge is mounted on the carriage may be used. Additionally, a line-head type printer in which no carriage is provided may also be used.

The control section 6 controls a liquid ejection operation, a liquid feeding operation, and a maintenance operation. For example, the control section 6 outputs a drive signal to the ink jet head 2 to control ejection of ink onto the recording medium. The control section 6 may be configured using, for example, a processing circuit such as a central processing unit (CPU) or a field programmable gate array (FPGA), and a storage circuit such as a semiconductor memory. In particular, in the present embodiment, the control section executes a first ejection step of ejecting the primer composition by an ink jet method and attaching the primer composition to the recording medium.

### EXAMPLES

The present disclosure will be described in more detail with reference to Examples below. The present disclosure is not limited by Examples below in any way.

### 1. Preparation of Primer Composition (Preparation Examples 1 to 4)

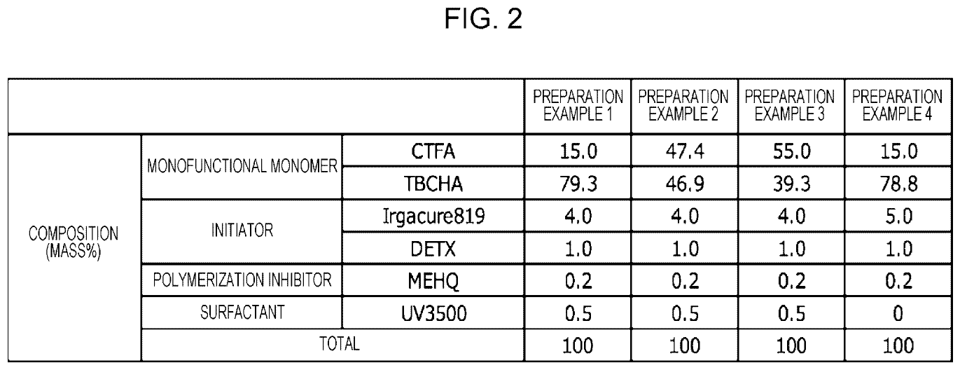

The polymerizable compounds, the photopolymerization initiator, and the polymerization inhibitor are put into a mixture tank, which is a stainless steel container, so as to achieve the composition shown in FIG. 2, mixed and stirred to be completely dissolved, further mixed and stirred at room temperature for 1 hour, and further filtered with a 5 μm membrane filter to obtain the primer composition of each example. Unless otherwise specified, numerical values of each component shown in each example in the table indicate mass %.

### 2. Preparation of Ink Composition (Preparation Example 5)

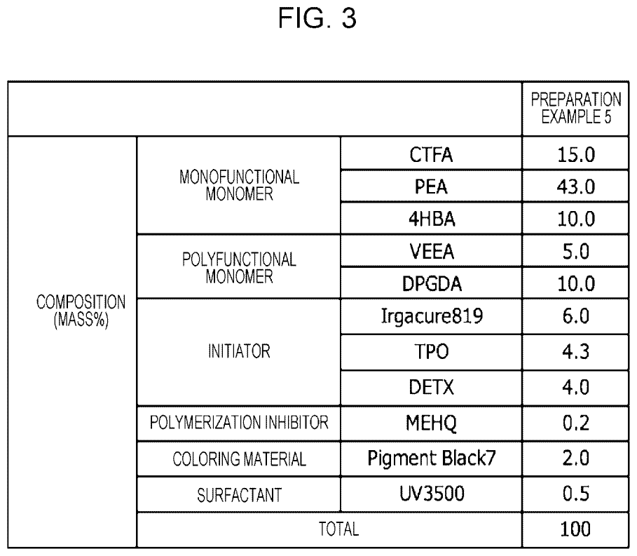

First, a coloring material and a part of each polymerizable compound are weighed and put into a pigment dispersing tank, and a ceramic bead mill having a diameter of 1 mm is put into the tank, followed by stirring to obtain a pigment dispersion liquid in which the coloring material is dispersed in monomers. Next, the remaining polymerizable compounds, the photopolymerization initiator, the polymerization inhibitor, and a slip agent are put into a mixture tank, which is a stainless steel container, and mixed and stirred to be completely dissolved so as to achieve the composition shown in FIG. 3, and the pigment dispersion liquid obtained above is added, mixed and stirred for 1 hour at room temperature, and filtered through a 5 μm membrane filter to obtain the ink composition of each example. Unless otherwise specified, numerical values of each component shown in each example in the table indicate mass %.

Abbreviations and product components used in FIG. 2 and FIG. 3 are as follows.
Polymerizable compound
CTFA (product name: “Viscoat #200,” manufactured by OSAKA ORGANIC CHEMICAL INDUSTRY LTD., cyclic trimethylolpropane formal acrylate)
TBCHA (tert-butyl cyclohexanol acrylate, manufactured by KJ Chemicals Corporation)
PEA (product name: “Viscoat #192,” manufactured by OSAKA ORGANIC CHEMICAL INDUSTRY LTD., phenoxyethyl acrylate“) 4HBA (Mitsubishi Chemical Corporation, 4-hydroxybutyl acrylate)
VEEA (manufactured by NIPPON SHOKUBAI CO., LTD., 2-(2-Vinyloxyethoxy)ethyl acrylate)
DPGDA (product name “SR508,” manufactured by Sartomer, dipropylene glycol).
Photopolymerization initiator
Irgacure 819 (product name: “IRGACURE 819,” bis(2,4,6-trimethylbenzoyl)-phenylphosphine oxide, manufactured by BASF SE)
TPO (product name: “IRGACURE TPO,” 2,4,6-trimethylbenzoyl diphenylphosphine oxide, manufactured by BASF SE)
DETX (product name: “Speedcure DETX,” 2,4-diethylthioxanthone, manufactured by Lambson Ltd.)
Polymerization inhibitor
MEHQ (product name: “p-methoxyphenol,” hydroquinone monomethyl ether, manufactured by Kanto Chemical Co., Inc.)
Slip agent
BYK-UV3500 (a polyether-modified polydimethylsiloxane having an acryloyl group, manufactured by BYK Additives & Instruments)
Coloring material
Pigment Black 7

### 3. Preparation of Recorded Matter

### Example 1

The primer composition obtained in Preparation Example 1 was attached to a polypropylene film (FOS-BT, manufactured by FUTAMURA CHEMICAL CO., LTD.) using a printer equipped with an LED (modified machine of SC-V1050, manufactured by Seiko Epson Corporation) such that the duty becomes 5%. At this time, the recording resolution of the primer composition is adjusted to 720×720 dpi, and the droplet weight of the primer composition is adjusted to 12 ng/dot. Then, the primer composition is irradiated with ultraviolet rays of 200 mJ/cm² and cured to form a primer layer. At this time, an LED having a peak wavelength at 395 nm is used as a light source. Further, the time from ejection of the primer composition to ultraviolet irradiation is set to be 120 seconds.

Thereafter, the ink composition obtained in Preparation Example 5 is attached to the primer layer using a printer equipped with an LED (modified machine of SC-V1050, manufactured by Seiko Epson Corporation) such that the duty becomes 100%. At this time, the recording resolution of the ink composition is adjusted to 720×720 dpi, and the droplet weight of the ink composition is adjusted to 12 ng/dot. Next, the ink composition is irradiated with ultraviolet rays of 300 mJ/cm² and cured to obtain recorded matter. At this time, an LED having a peak wavelength at 395 nm is used as a light source.

### Examples 2 to 14 and Comparative Examples 1 to 3

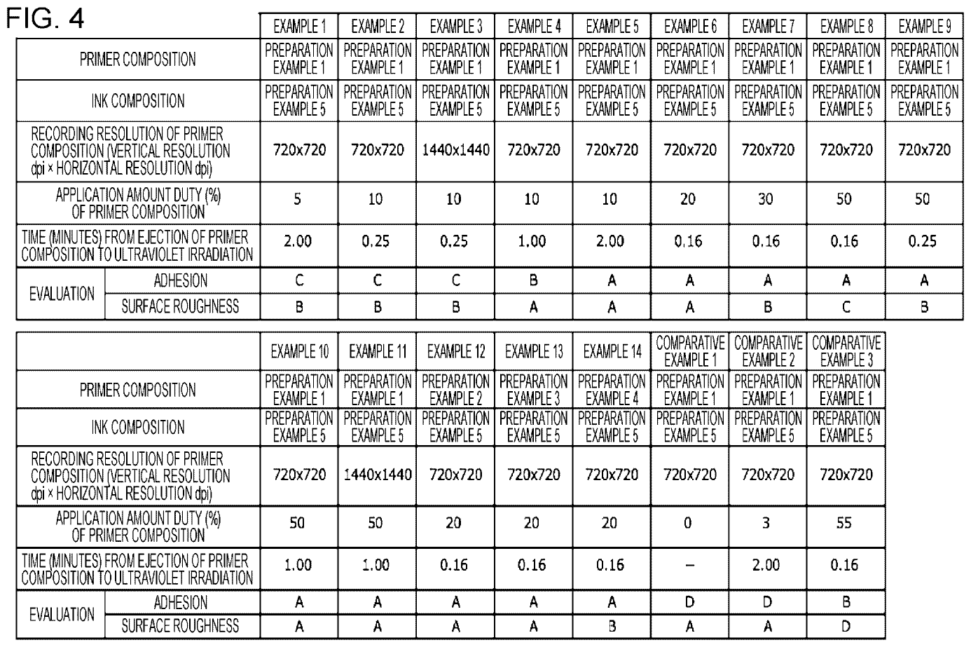

Recorded matter of each of Examples 2 to 14 and Comparative Examples 1 to 3 is obtained by the same method as in Example 1 except that the primer composition, the duty, the recording resolution, and the time from the ejection of the primer composition to the irradiation with ultraviolet rays in Example 1 are changed to the conditions described in FIG. 4. When the recording resolution of the primer composition is 1440×1440 dpi, the droplet weight of the primer composition is adjusted to 5 ng/dot. In Comparative Example 1, the steps of primer ejection and ultraviolet irradiation are omitted, and the ink composition is directly attached to a polypropylene film.

### 4. Evaluation Methods

### 4. 1. Evaluation of Adhesion

The recorded matter of each of Examples and Comparative Examples is evaluated by a cross-cut method in accordance with JIS K5600-5-6. To be specific, a blade of a cutting tool is brought into contact with the cured film so as to be perpendicular to the cured film, squares are formed so that the distances between adjacent incisions are 2 mm to form a 5×5 grid pattern with a cutter, a transparent adhesive tape (25 mm width) having a length of about 75 mm is attached, and the tape is sufficiently rubbed with a finger so that the cured film is visible through. Next, within 5 minutes from the attachment of the tape, the tape is reliably peeled off from the cured film at an angle close to 60° over 0.5 to 1.0 seconds, and the state of the grid pattern is visually observed. The evaluation criteria are as follows. Ratings A, B, and C are considered as acceptable, and D is considered as unacceptable.
A: No delamination of the grid pattern is observed.
B: The number of squares peeled is 1 to 5.
C: The number of squares peeled is 6 to 14.
D: The number of squares peeled is 15 to 25.

### 4. 2. Evaluation of Surface Roughness

The surface of the recorded matter of each of Examples and Comparative Examples was visually observed. The evaluation criteria are as follows. Ratings A, B, and C are considered as acceptable, and D is considered as unacceptable.
A: The surface is uniform and smooth.
B: Part of the surface is rough.
C: Less than half of the surface is rough.
D: More than half of the surface is rough.

### 5. Evaluation Results

From FIG. 4, in Examples 1 to 14 in which the primer composition was attached to the recording medium so that the duty was 5% to 50%, adhesion is excellent and surface roughness can be suppressed.

Specifically, when Examples 1 to 14 are compared with Comparative Examples 2 and 3 in which the primer composition was attached to the recording medium at a duty outside the range of 5% to 50%, it is indicated that Examples 1 to 14 can achieve both adhesion and suppression of surface roughness.

In addition, when Examples 1 to 14 are compared with Comparative Example 1, it is indicated that Comparative Example 1 in which the primer composition is not applied is inferior in adhesion of the ink composition.

What is claimed is:

1. An ink jet recording method comprising:
a first ejection step of ejecting a primer composition from an ink jet head to attach the primer composition to a recording medium so that a duty calculated by a formula (1) is 5% to 50%;
a first irradiation step of curing the primer composition attached to the recording medium by radiation irradiation to form a primer layer; and
a second ejection step of ejecting an ink composition to attach the ink composition onto the primer layer.
$$( 1 ) : Duty = ( number of actual printed dots ) / ( vertical resolution \times horizontal resolution ) \times 100$$

2. The ink jet recording method according to claim 1, wherein
the primer composition contains at least one compound (A) selected from an ether ring-containing polymerizable compound (A-1) and a saturated hydrocarbon ring-containing polymerizable compound (A-2).

3. The ink jet recording method according to claim 1, wherein
the primer composition contains the ether ring-containing polymerizable compound (A-1) and the saturated hydrocarbon ring-containing polymerizable compound (A-2).

4. The ink jet recording method according to claim 2, wherein
a content of the compound (A) in the primer composition is 85% by mass or more with respect to a total amount of a polymerizable compound.

5. The ink jet recording method according to claim 1, wherein
the primer composition does not contain a coloring material, or
a content of the coloring material in the primer composition is 1% by mass or less with respect to a total amount of the primer composition.

6. The ink jet recording method according to claim 1, wherein
a content of a photopolymerization initiator in the primer composition is 5% by mass or more with respect to a total amount of the primer composition.

7. The ink jet recording method according to claim 1, wherein
a content of a monofunctional monomer in the ink composition is 60% by mass or more with respect to a total amount of a polymerizable compound.

8. The ink jet recording method according to claim 1, wherein
a recording resolution of the primer composition is 600×600 dpi or more in the first ejection step.

9. The ink jet recording method according to claim 1, wherein
a time from ejection of the primer composition in the first ejection step to the radiation irradiation in the irradiation step is 5 seconds or more.

10. The ink jet recording method according to claim 1, wherein
in the first ejection step, the primer composition is ejected when the ink jet head is moved in a scanning manner in a width direction intersecting a transport direction of the recording medium.

11. The ink jet recording method according to claim 1, further comprising
a winding step of winding the recording medium to which the ink composition is attached.
